(19) United States
(12) Patent Application Publication
(10) Pub. No.: US 2010/0117408 A1
(43) Pub. Date: May 13, 2010

(54) Safety Seat Secured to a Support Frame Comprised of Spring Elements

(76) Inventor: Holger Hansen, Hamburg (DE)

Correspondence Address: ROBERT W. BECKER & ASSOCIATES, 707 HIGHWAY 333, SUITE B, TIJERAS, NM, 87059-7507, US

(21) Appl. No.: 12/530,565

(22) PCT Filed: Feb. 26, 2008
(86) PCT No.: PCT/EP2008/001499

§ 371 Date: Oct. 14, 2009

(30) Foreign Application Priority Data
Mar. 9, 2007 (DE) 10 2007 011 962.5

(51) Int. Cl. B60N 2/42; B60N 2/005; B60N 2/02; B60R 21/02; B60R 22/00

(52) U.S. Cl. 297/216.1

(57) ABSTRACT

A safety seat for land vehicles, aircraft and watercraft. A support frame is fixed to the vehicle and is provided with at least two generally vertical support elements, each comprised of a spring element loosely positioned between a roof region and a floor of the vehicle and bendable transverse to its longitudinal direction under load. Opposite sides of a sitting portion are secured to one of the spring elements via respective support straps and suspension straps. One end of each support strap is attached to the sitting portion near the front edge and extends at an angle to the longitudinal axis of the spring element toward the roof portion. The other end of the support strap is attached to a securement device fixedly connected to the spring element. One end of each suspension strap is attached near the rear edge of the sitting portion. The suspension strap extends from the sitting portion in a path generally parallel to the spring element to the securement device, to which another end of the suspension strap is secured. Near where the securement device is diposed on the spring element, a spacer is disposed between the suspension strap and the spring element.

The present invention relates to a safety seat for land vehicles, aircraft and watercraft, and includes a sitting portion that is secured to a support frame fixed to a vehicle and comprised of at least two vertical support elements.

A safety seat having the aforementioned features is known from DE 2004 062 350 B3. Herewith the seat is respectively secured to support straps, which are vertically suspended between the roof of the vehicle and the floor of the vehicle, in that the seat is secured to the vertical support straps by means of additionally provided, lateral carrying straps that are connected with the vertical support straps and form therewith a belt framework for the support of the seat. In this connection, the lateral carrying straps are comprised of a strap portion that extends from a lower, stationary securement location along the side edges of the seat to its front corners, whereby from the front corner points of the seat, a respective further strap portion, which extends at an angle to the vertical axis of the vehicle seat, is guided back to an upper, stationary securement location on the associated vertical support strap. Thus, the seat is placed into the belt framework formed from the vertical support straps and carrying straps in such a way that the seat automatically spreads out the belt framework.

The known safety seat has the drawback that when the sitting portion is loaded by a person sitting thereon, the vertically suspended support straps are correspondingly loaded, so that the roof of the vehicle and the floor of the vehicle are stressed in the vertical “Z” axis, accordingly in response to bending. In particular to the extent that the pertaining vehicles are to serve as troop transports in which a number of people are seated next to one another in a row, a considerable bending stress can occur in the associated roof region and/or floor region. In particular light vehicles or craft, such as aircraft, are above all not designed in their roof region for such bending stresses, so that the arrangement of a large number of safety seats in the vehicle is problematic. Due to the generally cramped and confined space conditions, the arrangement of additional supports and/or roll over members for the reinforcement of the vehicle structure is often not possible, and is at least obstructive for the function of the vehicles.

It is therefore an object of the present invention to embody a safety seat having the aforementioned general features in such a way that its securement in the vehicle is connected with as low as possible of a force introduction into the vehicle structure in the from of bending forces or moments. A further object is to design the safety seat in such a way that also the impulse forces that occur in the event that the vehicle is thrown upwardly during a mine explosion, or during a crash accompanied by rolling of the vehicle, are at least reduced in the safety seat.

The realization of the preceding object, including advantageous embodiments and further developments of the invention, results from the content of the patent claims that follow this description.

The basic concept of the invention is that the vertical support elements are each comprised of a spring element that is loosely positioned between the roof region and the floor of the vehicle and is bendable transverse to its longitudinal direction under load, and in that both, i.e. opposite, sides of the sitting portion are secured to the spring elements, on the one hand via a support strap, one end of which is attached in the vicinity of the front edge of the sitting portion and extends at an angle to the longitudinal axis of the spring element in the direction of the roof region of the vehicle, and the other end of which is attached to a securement device that is fixedly connected to the spring element, and on the other hand via a suspension strap, one end of which is attached in the vicinity of the rear edge of the sitting portion, and, in a path extending generally in the same direction as does the spring element, is guided to the securement device and is secured thereto via a second end, whereby near where the securement device is disposed on the spring element, a spacer for the suspension strap is disposed between the suspension strap and the spring element.

The present invention has the advantage that no fixed connection is provided between the vehicle structure and the spring elements as supports for the sitting portion. To the extent that a tensioning of the spring elements doesn't even occur until a person sits on the sitting portion, the forces that then occur are compressive forces that are introduced into the floor of the vehicle, whereas lateral support forces that act upon the vehicle roof, or in any event in the roof plane, namely in the “X” or “Y” direction, are effective for the upper end of the spring elements. To this extent, in particular in the roof region of the vehicle, the occurrence of bending forces is avoided. In this connection, the vehicle floor can more readily be stressed in the direction of the “Z” axis with compressive forces than with the pulling forces that occur with the state of the art and that cause a bending stress. Finally, the spring elements that support the sitting portion dampen the impacts originating from the vehicle during a possible stressing. Furthermore, the sitting portion is distanced from the spring elements by means of the support straps and suspension straps that carry it, thereby bringing about an effective uncoupling of the sitting portion from the vehicle structure.

Due to the inventive arrangement of the support strap, when the sitting portion is loaded by a person sitting thereon, the force is introduced in a pointwise manner into the spring elements at the position of the securement device; also the forces absorbed by the suspension straps upon loading of the sitting portion are introduced at the securement device into the spring elements, whereby due to the essentially parallel path of suspension strap and spring element by means of the disposition of a spacer, there is ensured that the forces introduced from the suspension strap into the pertaining spring element have a component in a direction transverse to the spring element, so that as a result the force introduced from the support strap is intensified and thus the spring element is stressed in response to bending in the manner of a stretched arch.

Pursuant to one embodiment of the invention, the ends of the spring elements can be respectively loosely positioned in support means secured to the roof region as well as to the floor. This has the advantage that when the spring elements bend in the manner of a stretched arch in the event of stress, they can shift in the support means.

The spring elements are preferably embodied in the manner of a leaf or plate spring, in particular as a leaf or plate spring set. The number of leaf or plate springs that are joined together to form a corresponding leaf or plate spring set, and their thickness and width, are a function of the required length of the spring elements, which results from the respective requirements on the vehicle, its headroom, and the possibilities for securement.

Pursuant to one embodiment of the invention, the spring elements can be comprised of a spring steel.

Pursuant to an embodiment of the invention, the securement device can be embodied as a clamp.

If pursuant to an embodiment of the invention the end of each suspension strap that is attached in the vicinity of the rear edge of the sitting portion is embodied in the manner of a loop that extends loosely around the sitting portion, the advantage is obtained that the sitting portion can be folded up in the loop into a vertical position that is approximately parallel to the orientation of the spring elements. In this connection, for the appropriate guidance, in the region of the plane of the sitting portion a ring loop made of a flexible material, and which loosely extends about the suspension strap and the spring element, can be provided.

If the safety seat, in a manner known from the aforementioned DE 2004 062 350 B3, is equipped with a safety harness for securing an occupant seated on the seat, then pursuant to an embodiment of the invention the upper end of the shoulder strap or of the shoulder straps can be secured to the spring element or the spring elements, and the ends of the lap belt can be secured to the sitting portion.

Furthermore, in a manner known per se, the safety seat can be provided with a back support and/or with side supports.

One embodiment of the invention, which will be described subsequently, is shown in the drawings, in which:

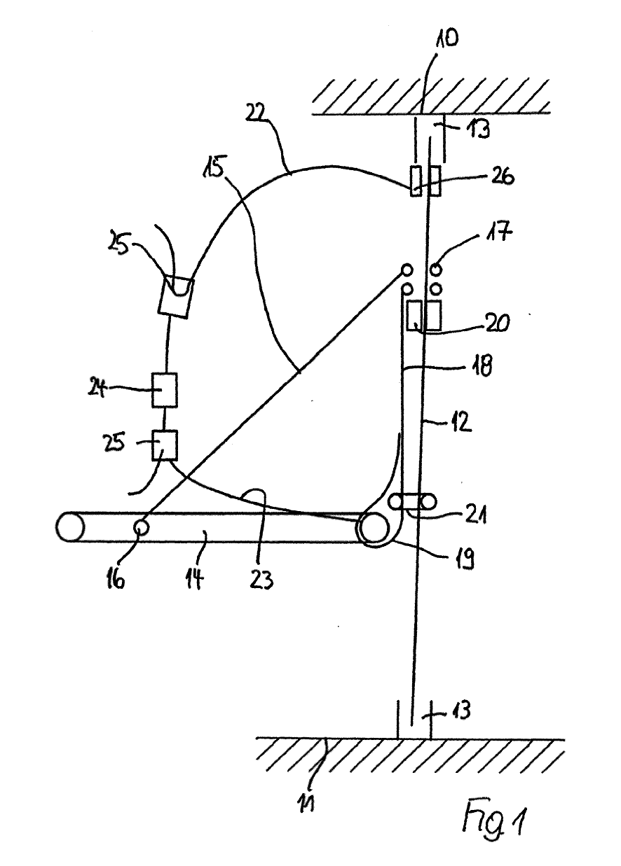

FIG. 1: is a schematic side view, in an unloaded state, of a safety seat together with the support means,

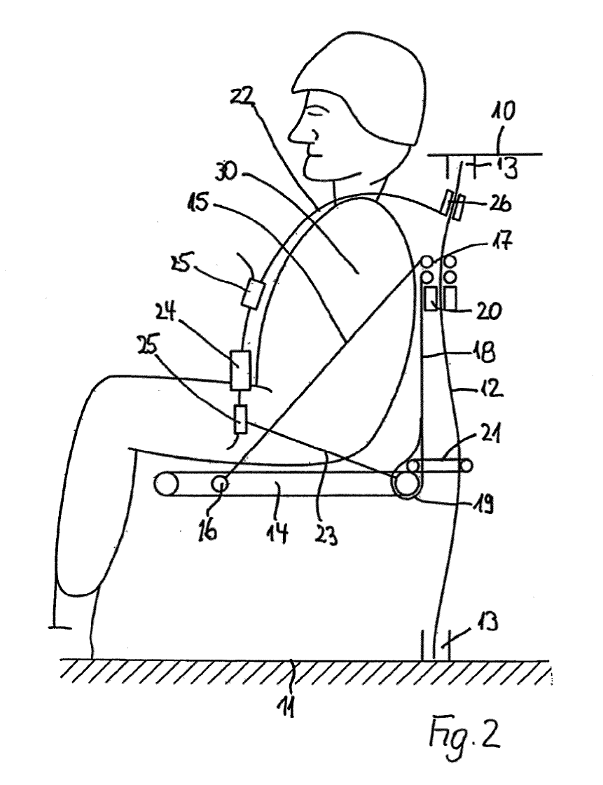

FIG. 2: shows the safety seat of FIG. 1 under load, with a person sitting thereon.

As can be seen initially from FIG. 1, disposed between the roof region 10 and the floor 11 of a vehicle is a spring element 12, the two outer ends of which are loosely disposed in respective support means 13 arranged on the roof region 10 and floor 11. In the unloaded state shown in FIG. 1, the spring element has a linear orientation. The spring element is comprised of a leaf or plate spring set that is preferably formed from a plurality of leaf or plate springs, whereby the individual leaf or plate springs can be made of a conventional spring steel. The number of leaf or plate springs, their thickness and width are a function of the length, which results from the respective requirement of the vehicle, its headroom, and the possibilities for the support of the spring element.

If a sitting portion 14 is to be secured in position on the corresponding spring elements, two spring elements 12 are respectively spaced apart by the distance of the width of the sitting portion 14, so that a sitting portion is respectively carried by two spring elements 12 in a manner to be described subsequently. In a manner known per se, the sitting portion can be comprised of a rigid seat frame and a seat covering, preferably of a textile material, that is secured to the frame.

Both sides of the sitting portion 14 are secured to the pertaining element 12 by a support strap 15, one end of which is attached at a mounting location 16 disposed in the vicinity of the front edge of the sitting portion; the other end of the support strap 15, which extends at an angle relative to the longitudinal axis of the spring element 12 and in the direction of the roof region 10 of the vehicle, is attached to the spring element 12 by means of a securement device 17 that is fixedly connected with the spring element 12. Since no bore is to be provided in a suitable spring steel, the securement device 17 is preferably embodied as a clamp or a clamping device. For the further, additional securement of the sitting portion 14, a suspension strap 18 is provided, one end of which is formed into a loop 19 and holds the sitting portion 14 in the vicinity of its rear edge, with the suspension strap being guided upwardly, in a path that extends in the same direction as does the unloaded spring element 12, to the securement device 17, where it is also secured. Disposed below the securement device 17, in the immediate vicinity thereof, is a spacer 20 that serves to provide a spacing between the suspension strap 18 and the spring element 12. Furthermore, provided in the region of the plane of the sitting portion 14 is a ring loop 21, which is made of an elastic material, and which loosely extends about the suspension strap 18 and the spring element 12.

To secure a person sitting on the sitting portion 14, a safety harness is provided that is comprised of one or two shoulder straps 22 that are secured to the associated spring element 12 at 26; the length of the shoulder straps can respectively be adjusted be means of an inserted adjustment device 25. Also provided is a lap belt 23, the two ends of which are respectively secured to the seat frame of the sitting portion 14; the lap belt 23 is also provided with an adjustment device 25. Lap belt 23 and shoulder strap 22 or shoulder straps 22 are joined together in a central rapid release snap-type buckle 24.

As can be seen from FIG. 2, a loading of the sitting portion 14 by a person 30 sitting thereon leads to the entire force being introduced into the securement device 17 via the support strap 15 as well as the suspension strap 18; as a consequence thereof, the spring element 12, or the two spring elements 12 that carry a sitting portion 14, bend or sag in the manner schematically indicated in FIG. 2, so that a type of arching tension results. The loop 21, which is made of an elastic material, follows this bending or bulging.

The suspension of the rear end of the sitting portion 14 in the loops 19 formed by the suspension straps 18 on both sides provides the possibility of folding the sitting portion in the two loops 19 into a vertical position, thus providing a space-saving storage.

The features of the subject matter of these documents disclosed in the preceding specification, the claims, the abstract and the drawings can be important individually as well as in any desired combination with one another for realizing the various embodiments of the invention.

1-11. (canceled)

12. A safety seat for land vehicles, aircraft, and watercraft, comprising:
a support frame that is adapted to be fixed to a vehicle, wherein said support frame is provided with at least two generally vertical support elements, each of which is comprised of a spring element that is adapted to be loosely positioned between a roof region and a floor of the vehicle and is bendable transverse to its longitudinal direction under load; and
a sitting portion secured to said support frame, wherein opposite sides of said sitting portion are secured to one of said spring elements via respective support straps and suspension straps, further wherein a first end of each of said support straps is attached to said sitting portion in the vicinity of a front edge of said sitting portion, further wherein said support strap extends at an angle relative to a longitudinal axis of said spring element in the direction of the roof region, further wherein a securement device is fixedly connected to said spring element, further wherein a second end of said support strap is attached to said securement device, further wherein a first end of each of said suspension straps (18) is attached to said sitting portion in the vicinity of a rear edge of said sitting portion, further wherein said suspension strap extends from said sitting portion, in a path extending generally in the same direction as does said spring element, to said securement device, to which a second end of said suspension strap is secured, and wherein near where said securement device is disposed on said spring element, a spacer is disposed between said suspension strap and said spring element.

13. A safety seat according to claim 12, wherein ends of said spring elements are respectively loosely positioned in support means secured to the roof region and the floor of the vehicle.

14. A safety seat according to claim 12, wherein said spring elements are embodied in the manner of a leaf or plate spring.

15. A safety seat according to claim 12, wherein said spring elements are embodied as a leaf or plate spring set.

16. A safety seat according to claim 12, wherein said spring elements are comprised of a spring steel.

17. A safety seat according to claim 12, wherein said securement device is embodied as a clamp.

18. A safety seat according to claim 12, wherein said first end of each of said suspension straps that is attached in the vicinity of the rear edge of said sitting portion is embodied in the manner of a loop that extends loosely around said sitting portion.

19. A safety seat according to claim 18, wherein in the region of a plane of said sitting portion, a ring loop made of an elastic material extends loosely around said suspension strap (18) and said spring element.

20. A safety seat according to claim 12, which further comprises a safety harness for securing an occupant seated on said seat, wherein said safety harness includes at least one shoulder strap and a lap belt, further wherein an upper end of said at least one shoulder strap is secured to at least one spring element, and wherein ends of said lap belt are secured to said sitting portion.

21. A safety seat according to claim 12, which is provided with a back support.

22. A safety seat according to claim 12, which is provided with side supports.
